(19) United States
(12) Patent Application Publication
(10) Pub. No.: US 2026/0107922 A1
(43) Pub. Date: Apr. 23, 2026

(54) THERAPEUTIC PET BOOT

(71) Applicant: Beth Morris, Louisville, TN (US)

(72) Inventor: Beth Morris, Louisville, TN (US)

(21) Appl. No.: 19/361,258

(22) Filed: Oct. 17, 2025

Related U.S. Application Data
(60) Provisional application No. 63/710,307, filed on Oct. 22, 2024.

(51) Int. Cl. A01K 13/00; A01L 9/00

(52) U.S. Cl. CPC A01K 13/007; A01L 9/00

(57) ABSTRACT

Various implementations include a pet boot. The boot includes a body and a cuff. The body has a top portion and a bottom portion coupled to the top portion. The top and bottom portions define an inner cavity and a leg opening extending to the inner cavity. The cuff includes a plurality of strands and a band. The plurality of strands each have a first end and a second end spaced apart and opposite the first end. The second end of each strand is coupled to the body adjacent the leg opening. The band forms a loop. The first end of each of the strands is coupled to the band. Each of the stands are spaced apart from each other around the leg opening such that a plurality of cuff openings are defined by the plurality of strands, the band, and the body.

### FIELD OF THE INVENTION

The invention relates to a pet boot; and more particularly to a pet boot having therapeutic properties provided by increased traction on slippery surfaces and easier control of bodily movements, while maintaining tactile sensitivity between pet paw and walking surface.

### BACKGROUND

Several disorders exist that can cause the simple act of walking to be painful and difficult for dogs suffering these disorders. Wobblers Syndrome, arthritis, and hip dysplasia are examples of such disorders.

Wobblers Syndrome is a serious and progressive condition in which an abnormality in the spine pinches the spinal cord. Also known as cervical vertebral instability (CVI), and alternatively spondylolithesis, Wobblers Syndrome is a condition that can affect puppies or adult dogs. Sufferers of this syndrome develop an unsteady gait due to spinal cord compression caused by the narrowing of the vertebral canal, or by a ruptured disc in the neck. This causes the vertebral ligaments to become loosened and overstretched (hypertrophy) to the point of an inability to tauten properly when strength is needed. The vertebrae can become malformed, or do not come together properly, which puts pressure on the spinal cord causing gait problems and moderate to severe discomfort.

Current treatment for dogs suffering from Wobblers Syndrome and similar disorders includes minimizing movement of the animal and providing an environment that requires less effort from the animal in order to walk. Flat, soft surfaces with few obstacles are preferred.

It is understood that dogs with walking disorders have more difficulty walking on slippery surfaces such as hardwood floors and tile. Also, it is understood that as they age otherwise healthy dogs have difficulty walking on hard slippery surfaces due to muscle atrophy (loss of muscle tissue due to malnutrition, less exercise, etc.) and stretched ligaments and tendons. Decreased traction on such surfaces force the animal to use more muscles and expend more energy in order to keep their feet from slipping out from under the animal. Such increased efforts, while hardly noticed by healthy dogs, make walking difficult and painful for older dogs and dogs suffering from Wobblers Syndrome and similar disorders. Also, because dogs suffering from Wobblers Syndrome and similar disorders are sensitive to impact with hard surfaces, simply walking on surfaces such as concrete, rocks, asphalt, tile, and hardwood floors can cause pain, bruising, and foot-pad injury.

Therefore, increasing traction between the bottom of the dog's feet and the surface being walked upon is desirable. Also, cushioning the impact between foot and floor is desirable. Also, a boot that maintains a flat surface under the animal's foot-pads is desirable. The instant invention improves upon current art with respect to all of these issues.

While prior art has addressed shoes and/boots for animals for wear outside during inclement or cold weather, as well as for aesthetic purposes, and to facilitate healing of an injured paw, no boot or shoe has been proposed that provides the therapeutic properties disclosed by the instant invention. While currently available shoes and/boots prevent animals from reinjuring paws and legs after treatment by covering said appendages during healing, such art does not provide the therapeutic properties related to chronic disorders, as disclosed by the instant invention.

Additionally, because dogs rely upon tactile feedback from their paws in order to maximize balance and efficiency of movement while walking and running, it is desirable that shoes and/boots for animals minimize interference between the animal's paw and the ground. Pet boots currently available in the art significantly decrease tactile feedback between the pet's foot and the ground.

Also, pet boots currently available in the art provide coverings that minimize or eliminate airflow around the pet's paws. While such boots prevent water and other environmental debris from contacting the paw, such boots also retain any water and debris that may be on the paw when the boots are placed on the animal. Because dogs regulate their body heat in part by sweating through the surface of their paw pads, boots that do not allow sufficient air flow result in moisture build up around the paw. Moisture and dirt inside a pet boot can cause discomfort to the animal, and may lead to bacterial infection, mold, or other problems. Improving air flow would allow the animal to comfortably wear a boot longer, thereby minimizing disturbance to the dog. It is, therefore, desirable for pet boots to maximize air flow around the paws, allowing moisture to escape and debris to naturally dislodge.

It is also desirable to provide a pet boot that allows easy inspection of the animal's foot without removing the boot. Prior art animal boots do not allow easy inspection of the animal's foot without removing the boot.

Finally, it is well understood by all pet owners that most animals initially resist having boots placed on their feet, and attempt to remove such boots once the boots are secured to the animal's feet. While prior art addresses these issues in various ways, it is clear that improved designs for increasing ease of placing boots on the animal's feet and increasing security of the boots once in place, are desirable.

In contrast to the efforts of prior art workers which heretofore have simply constructed pet boots and shoes to be worn by a pet to prevent injury, aid healing, or prevent the animal from clawing furniture, there is a need in the art for a therapeutic pet boot appointed to be worn by a pet with a chronic walking disability. There remains a need in the art for a therapeutic pet boot that provides increased traction, shock absorption, increased tactile sensation, breathability, increased ability to visually inspect the animal's foot while the boot is on, and improves ease of placing the boot on the animal.

### SUMMARY

Various implementations include a pet boot. The boot includes a body and a cuff. The body has a top portion and a bottom portion coupled to the top portion. The top portion and the bottom portion define an inner cavity and a leg opening defined by an outer surface of the body and extending to the inner cavity. The cuff includes a plurality of strands and a band. The plurality of strands each have a first end and a second end spaced apart and opposite the first end. The second end of each strand is coupled to the body adjacent the leg opening. The band forms a loop. The first end of each of the strands is coupled to the band. Each of the stands are spaced apart from each other around the leg opening such that a plurality of cuff openings are defined by the plurality of strands, the band, and the body.

In some implementations, the boot further includes a strap separately formed from the body and cuff. In some implementations, the strap is threaded through the plurality of cuff openings. In some implementations, the strap has a first end portion and a second end portion opposite and spaced apart from the first end portion. In some implementations, the first end portion is couplable to the cuff. In some implementations, the strap further has a middle portion disposed between the first end portion and the second end portion. In some implementations, the first end portion of the strap is couplable to the middle portion to form a strap loop. In some implementations, a strand of the cuff is disposable within the strap loop to couple the first end portion of the strap to the cuff.

In some implementations, the boot further includes an insert defining two or more insert openings. In some implementations, the strap is threaded through the two or more insert openings. In some implementations, the strap is threaded through the two or more insert openings such that at least one strand of the cuff is disposed between the strap and the insert. In some implementations, the strap has a first side and a second side opposite the first side. In some implementations, the insert includes one or more nubs extending away from the insert.

In some implementations, the second side of the strap defines one or more nub openings extending to the first side of the strap. In some implementations, the one or more nubs are disposable within the one or more nub openings. In some implementations, the insert has a higher durability than the strap.

In some implementations, the strap has a first side and a second side opposite the first side. In some implementations, the first side includes hooks of a hook-and-loop coupler. In some implementations, the second side includes loops of the hook-and-loop coupler. In some implementations, the first side includes one or more nubs extending away from the first side. In some implementations, the second side defines one or more nub openings extending to the first side. In some implementations, the one or more nubs are disposable within the one or more nub openings.

In some implementations, the strap includes an elastomer.

In some implementations, the top portion and the bottom portion of the body each define a plurality of body openings. In some implementations, the body openings extend from the outer surface of the body to the inner cavity. In some implementations, the body openings are quadrilateral. In some implementations, the body openings are circular or ovate. In some implementations, the body openings are hexagonal. In some implementations, the plurality of body openings of the top portion are a different shape than the plurality of body openings of the bottom portion.

In some implementations, a portion of the body opposite the leg opening comprises a toe guard portion. In some implementations, the toe guard portion of the top portion and the bottom portion of the body do not define body openings. In some implementations, the toe guard portion of the top portion and the bottom portion are each semi-circular shaped. In some implementations, the toe guard portion of the top portion and the bottom portion are each crescent shaped.

In some implementations, the body and cuff each include an elastomer.

In some implementations, the leg opening is configured to be positioned at the ankle of a pet in use.

In some implementations, the boot further includes an extension portion coupled to the body and extending proximally from the leg opening. In some implementations, the extension portion is configured to extend to or above a carpus or hock of the pet.

In some implementations, the extension portion defines a plurality of extension openings extending through the extension portion to provide airflow around the pet's limb. In some implementations, the extension portion comprises flexible strands arranged in a grid pattern, wherein the flexible strands define extension openings between the strands.

In some implementations, the cuff is a first cuff. In some implementations, the extension portion includes a second cuff spaced apart from the first cuff. In some implementations, the second cuff defines a plurality of second cuff openings circumferentially spaced around the extension portion. In some implementations, the boot further includes a second strap separately formed from the body, first cuff, second cuff, and extension portion. In some implementations, the second strap is threaded through the plurality of second cuff openings. In some implementations, the boot further includes a second insert defining two or more second strap insert openings. In some implementations, the second strap is threaded through the two or more second strap insert openings.

Various other implementations include a pet boot. The boot includes a body, a cuff, a strap, and an insert. The body has a top portion and a bottom portion coupled to the top portion. The top portion and the bottom portion define an inner cavity and a leg opening defined by an outer surface of the body and extending to the inner cavity. The cuff forms a loop. The cuff is coupled to the body around the leg opening. The cuff defines a plurality of cuff openings circumferentially spaced around the loop. The strap is separately formed from the body and cuff. The strap is threaded through the plurality of cuff openings. The insert defines two or more insert openings. The strap is threaded through the two or more insert openings.

In some implementations, the cuff includes a plurality of stands and a band. In some implementations, the plurality of strands each have a first end and a second end spaced apart and opposite the first end. In some implementations, the second end of each strand is coupled to the body adjacent the leg opening. In some implementations, the band forms a loop. In some implementations, the first end of each of the strands is coupled to the band. In some implementations, each of the stands are spaced apart from each other around the leg opening such that the plurality of cuff openings are defined by the plurality of strands, the band, and the body.

In some implementations, the strap has a first end portion and a second end portion opposite and spaced apart from the first end portion. In some implementations, the first end portion is couplable to the cuff.

In some implementations, the strap has a first end portion, a second end portion opposite and spaced apart from the first end portion, and a middle portion disposed between the first end portion and the second end portion. In some implementations, the first end portion of the strap is couplable to the middle portion to form a strap loop. In some implementations, a strand of the cuff is disposable within the strap loop to couple the first end portion of the strap to the cuff.

In some implementations, the strap is threaded through the two or more insert openings such that at least one strand of the cuff is disposed between the strap and the insert.

In some implementations, the strap has a first side and a second side opposite the first side. In some implementations, the insert includes one or more nubs extending away from the insert.

In some implementations, the second side of the strap defines one or more nub openings extending to the first side of the strap. In some implementations, the one or more nubs are disposable within the one or more nub openings. In some implementations, the insert has a higher durability than the strap.

In some implementations, the strap has a first side and a second side opposite the first side. In some implementations, the first side includes hooks of a hook-and-loop coupler. In some implementations, the second side includes loops of the hook-and-loop coupler. In some implementations, the first side includes one or more nubs extending away from the first side. In some implementations, the second side defines one or more nub openings extending to the first side. In some implementations, the one or more nubs are disposable within the one or more nub openings.

In some implementations, the strap includes an elastomer.

In some implementations, the top portion and the bottom portion of the body each define a plurality of body openings. In some implementations, the body openings extend from the outer surface of the body to the inner cavity. In some implementations, the body openings are quadrilateral. In some implementations, the body openings are circular or ovate. In some implementations, the body openings are hexagonal. In some implementations, the plurality of body openings of the top portion are a different shape than the plurality of body openings of the bottom portion.

In some implementations, a portion of the body opposite the leg opening includes a toe guard portion. In some implementations, the toe guard portion of the top portion and the bottom portion of the body do not define body openings. In some implementations, the toe guard portion of the top portion and the bottom portion are each semi-circular shaped. In some implementations, the toe guard portion of the top portion and the bottom portion are each crescent shaped.

In some implementations, the body and cuff each include an elastomer.

In some implementations, the leg opening is configured to be positioned at the ankle of a pet in use.

In some implementations, the boot further includes an extension portion coupled to the body and extending proximally from the leg opening. In some implementations, the extension portion is configured to extend to or above a carpus or hock of the pet.

In some implementations, the extension portion defines a plurality of extension openings extending through the extension portion to provide airflow around the pet's limb. In some implementations, the extension portion comprises flexible strands arranged in a grid pattern, wherein the flexible strands define extension openings between the strands.

In some implementations, the cuff is a first cuff. In some implementations, the extension portion includes a second cuff spaced apart from the first cuff. In some implementations, the second cuff defines a plurality of second cuff openings circumferentially spaced around the extension portion. In some implementations, the boot further includes a second strap separately formed from the body, first cuff, second cuff, and extension portion. In some implementations, the second strap is threaded through the plurality of second cuff openings. In some implementations, the boot further includes a second insert defining two or more second strap insert openings. In some implementations, the second strap is threaded through the two or more second strap insert openings.

Various other implementations include a pet boot. The boot includes a body and a cuff. The body has a top portion and a bottom portion coupled to the top portion. The top portion and the bottom portion define an inner cavity and a leg opening defined by an outer surface of the body and extending to the inner cavity. The cuff forms a loop. The cuff is coupled to the body around the leg opening. The cuff defines a plurality of cuff openings circumferentially spaced around the loop. The top portion and the bottom portion of the body each define a plurality of body openings. The body openings extend from the outer surface of the body to the inner cavity. A portion of the body opposite the leg opening comprises a toe guard portion. The toe guard portion of the top portion and the bottom portion of the body do not define body openings.

In some implementations, the body openings are quadrilateral. In some implementations, the body openings are circular or ovate. In some implementations, the body openings are hexagonal. In some implementations, the plurality of body openings of the top portion are a different shape than the plurality of body openings of the bottom portion.

In some implementations, the toe guard portion of the top portion and the bottom portion are each semi-circular shaped. In some implementations, the toe guard portion of the top portion and the bottom portion are each crescent shaped.

In some implementations, the boot further includes a strap separately formed from the body and cuff. The strap is threaded through the plurality of cuff openings.

In some implementations, the cuff includes a plurality of strands and a band. In some implementations, the plurality of strands each have a first end and a second end spaced apart and opposite the first end. In some implementations, the second end of each strand is coupled to the body adjacent the leg opening. In some implementations, the band forms a loop. In some implementations, the first end of each of the strands is coupled to the band. In some implementations, each of the stands are spaced apart from each other around the leg opening such that the plurality of cuff openings are defined by the plurality of strands, the band, and the body.

In some implementations, the strap has a first end portion and a second end portion opposite and spaced apart from the first end portion. In some implementations, the first end portion is couplable to the cuff.

In some implementations, the strap has a first end portion, a second end portion opposite and spaced apart from the first end portion, and a middle portion disposed between the first end portion and the second end portion. In some implementations, the first end portion of the strap is couplable to the middle portion to form a strap loop. In some implementations, a strand of the cuff is disposable within the strap loop to couple the first end portion of the strap to the cuff.

In some implementations, the boot further includes an insert defining two or more insert openings. In some implementations, the strap is threaded through the two or more insert openings. In some implementations, the strap is threaded through the two or more insert openings such that at least one strand of the cuff is disposed between the strap and the insert. In some implementations, the strap has a first side and a second side opposite the first side. In some implementations, the insert includes one or more nubs extending away from the insert.

In some implementations, the second side of the strap defines one or more nub openings extending to the first side of the strap. In some implementations, the one or more nubs are disposable within the one or more nub openings.

In some implementations, the insert has a higher durability than the strap.

In some implementations, the strap has a first side and a second side opposite the first side. In some implementations, the first side includes hooks of a hook-and-loop coupler. In some implementations, the second side includes loops of the hook-and-loop coupler. In some implementations, the first side includes one or more nubs extending away from the first side. In some implementations, the second side defines one or more nub openings extending to the first side. In some implementations, the one or more nubs are disposable within the one or more nub openings.

In some implementations, the strap includes an elastomer. In some implementations, the body and cuff each include an elastomer.

In some implementations, the leg opening is configured to be positioned at the ankle of a pet in use.

In some implementations, the boot further includes an extension portion coupled to the body and extending proximally from the leg opening. In some implementations, the extension portion is configured to extend to or above a carpus or hock of the pet.

In some implementations, the extension portion defines a plurality of extension openings extending through the extension portion to provide airflow around the pet's limb. In some implementations, the extension portion comprises flexible strands arranged in a grid pattern, wherein the flexible strands define extension openings between the strands.

In some implementations, the cuff is a first cuff. In some implementations, the extension portion includes a second cuff spaced apart from the first cuff. In some implementations, the second cuff defines a plurality of second cuff openings circumferentially spaced around the extension portion. In some implementations, the boot further includes a second strap separately formed from the body, first cuff, second cuff, and extension portion. In some implementations, the second strap is threaded through the plurality of second cuff openings. In some implementations, the boot further includes a second insert defining two or more second strap insert openings. In some implementations, the second strap is threaded through the two or more second strap insert openings.

The present invention provides a therapeutic pet boot. More specifically, the present invention discloses a new product for therapeutically increasing traction, providing shock absorption, increasing tactile sensation, increasing breathability, increased ability to visually inspect the animal's foot while the boot is on, and improving ease of placing the boot on the animal.

The primary aspect of the present invention is to provide a boot to increase the coefficient of friction between the bottom of a dog's paws and the surface upon which the dog walks.

Another aspect of the present invention is to provide a boot that absorbs part of the shock incurred upon the dog's body as it walks.

Another aspect of the present invention is to provide an animal boot that minimally interferes with the tactile interaction between the animal's foot and the ground.

Another aspect of the present invention is to provide a boot that is easy to take on and off the animal.

Another aspect of the present invention is to provide a boot that provides plenty of airflow for the comfort and foot health of the animal.

Another aspect of the present invention is to provide a boot that increases ability to visually inspect the animal's foot while the boot is on.

Another aspect of the present invention is to provide a boot that securely attaches to the animal.

Another aspect of the present invention is to provide an overboot that easily fits over the first boot, securely attaches to the animal, temporarily protects the first boot from abrasion, and protects the animal's paw from environmental extremes.

Other aspects of this invention will appear from the following description and appended claims, reference being made to the accompanying drawings forming a part of this specification wherein like reference characters designate corresponding parts in the several views.

An animal boot is provided comprising strands of Liquid Silicone Rubber (LSR) or similar flexible material manufactured laid out in parallel and at right angles to create a grid of approximately one sixteenth inch average diameter. A cross section of the LSR strands reveals an oval shape to provide increased comfort for the animal. The LSR strands are provided with the widest portion of their cross section in a horizontal position. The grid consists of multiple rectangle-shaped or quadrilateral-shaped spaces. Each such spaces are approximately one quarter inch wide by three eighths inches long. To be clear, the spaces between the strands of LSR do not create a solid surface across the grid cells. Instead, the cells are open to allow air flow through the LSR-strand grid.

A bottom portion of the boot consists of a section of LSR-strand grid, the bottom portion of the boot being rectangular at one end and semi-circular at the other end. The flat end at the rectangular end of the bottom portion is the rear of the boot. The bottom portion of the boot is approximately five and one half inches long, oriented with the shorter spaces between LSR-strand grids facing either side of the bottom of the boot.

A top portion of the boot consists of a section of LSR-strand grids, cut in the same shape as the bottom portion and oriented in the same manner as the bottom portion of the boot, and connected to the bottom portion of the boot along the edge of both top and bottom. The semi-circular end of the attached top and bottom portions is the front of the boot. The top and bottom portions of the boot are not attached at the rear end of the boot, thereby leaving an opening for the animal's paw to enter the boot.

The top portion of the boot is approximately one and one half inches shorter than the bottom portion, thereby leaving a one and one half inch section of the bottom portion exposed at the rectangular end of the boot after the top portion is attached to the bottom.

The rear end of the boot has a strap attached to it for tightening the boot around the leg of the animal. A section of hook and loop fastener is attached at one end of the strap to allow for tightening of the boot around the animal's ankle at the rear of the boot. The strap is approximately ten inches in length and is attached to the rear end of the boot at the bottom on one side of the boot. After the animal's paw is placed in the boot the strap is wrapped around the top of the animal's ankle and underneath the rear end of the boot in order to secure the boot on the animal's paw. Another section of hook and loop fastener is attached to the bottom of the rear end of the boot to provide secure attachment of the strap to the bottom of the rear end of the boot. It is understood that for the purposes of this specification the term “the animal's ankle” means the joint distal to the wrist just above the forefoot on the front legs of the animal and also means the joint distal to the hock just above the animal's hind feet.

In alternate embodiments the strands of Liquid Silicone Rubber (LSR) or similar flexible material laid out in parallel and at right angles to each other, are oriented at an angle to the rear of the boot to create a grid of diamond shaped squares, rectangles, or other quadrilaterals.

In alternate embodiments all dimensions of the boot are increased or decreased to accommodate animals with larger or smaller paws. For example, smaller dogs will benefit from thinner LSR strands and closer spacing of strands, resulting in smaller openings in the LSR grid. Whereas larger dogs will require thicker strands with wider spaced grids.

In an alternate embodiment the boot is secured to the animal's foot by alternate means. In this embodiment the strap is not part of the invention. The bottom portion of the boot is extended to equal the length of the top portion. The top and bottom portions are not connected at the side rear 1-inch portions, providing a slit on both sides to facilitate insertion of the animal's paw into the boot. A loosely woven (breathable), stretchy material or fabric collar is fused onto each of the rear 1-inch sections of the bottom and top boot portions. At one side of the bottom rear of the boot near the slit a length of hook fastener, enough to fully reach around to the back of the bottom of the boot, is fused or sewn to the boot. Along the length of the rear portion of the top portion of the boot and along the length of the rear of the bottom portion of the boot, a length of loop fastener is attached. The hook fastener on the strap aligns with the loop fasteners when the strap is wrapped around the animal's ankle for securing at the back of the animal's ankle.

In another alternative embodiment an elastic cord with cord lock is encased inside the fused collar, said elastic cord protruding from the collar at one side where it extends outside the collar openings, allowing the boot to be tightened onto the foot.

In an alternate embodiment high-tensile strength threads of approximately one sixteenth inch average diameter woven into a mesh and covered with Liquid Silicone Rubber (LSR) or similar flexible material. A cross section of the threads reveals an oval shape to provide increased comfort for the animal. The threads are woven with the widest portion of their cross section in a horizontal position and the LSR is deposited on the threads in a manner that leaves a grid of LSR-covered threads. The grid creates multiple quadrilateral-shaped (e.g., rectangle-shaped) empty spaces between the LSR-covered threads. Each such space is approximately one quarter inch wide by three eighths inches long. While the LSR covers the woven threads, LSR does not create a solid surface across the cells between the woven threads. The cells are open to allow air flow through the LSR-covered woven threads. In this embodiment the thread-covered LSR, and the grid created by the thread-covered LSR, comprise the material used to form the top and bottom of the boot.

In another alternate embodiment the woven threads are not woven, but are instead laid out across each other in a pattern creating quadrilateral (e.g., square or rectangular) cells.

In other alternate embodiments other elastomer materials are used in place of LSR. Molding or injection molding, or extrusion, or hand sewn and glued manufacturing methods may be used to create the top and bottom portions of the boot. Elastomers may include, but are not limited to saturated rubbers, unsaturated rubbers, thermoplastic elastomers, resilin and related elastomeric proteins, elastin and related elastic fibers, polysulfide rubber, latex, nylon, elastic fiber (such as elastolefin), and other flexible semi-rigid materials. Unsaturated rubbers may include, but are not limited to, natural polyisoprene, synthetic polyisoprene, chloroprene rubber (such as Neoprene), butyl rubber (such as halogenated and bromo), and nitrile rubber. Saturated rubbers may include, but are not limited to ethylene propylene rubber, ethylene propylene diene rubber, silicone rubber, fluorosilicone rubber, fluoroelastomers, chlorosulofonated polyethylene, and perfluoroelastomers.

In yet other alternate embodiments urethane materials are used in place of LSR. Molding or reaction injection molding manufacturing methods may be used to create the top and bottom portions of the boot, as well as the strap portion of the boot. Urathanes include, but are not limited to polyurethane and viscoelastic urethane polymer.

In other alternate embodiments aromatic polyamides, such as Kevlar or Nomex may be used to form the boot using sewing or adhesives or in combination.

In other alternate embodiments leather, tanned or rawhide, with or without puffy fabric paint may be used to form the boot. Hand sewn and glued manufacturing methods may be used.

In other alternate embodiments elastomeric plastic netting may be used to form the boot and may be hand sewn or manufactured via extrusion methods.

In other alternate embodiments flexible filaments may be used to form the boot and may be manufactured via extrusion, 3-dimensional printing, or additive manufacturing.

In other alternate embodiments nylons (polyamides) may be used to form the boot using molding, or extrusion, or 3-dimensional printing manufacturing methods.

In yet other alternate embodiments alternate means of securing the boot to the animal's paw are used. In one alternate embodiment elastic cords and cord locks are utilized in place of the hook and loop fasteners to secure the rear of the boot to the animal's ankle. In another embodiment rigid cordage is utilized to secure the rear of the boot to the animal's ankle.

In a preferred embodiment an extra-large animal boot is provided comprising a bottom portion of LSR strands of approximately ⅛th (one-eighth) inch diameter, laid out in a grid pattern. The grid of LSR strands are laid out to leave multiple quadrilateral (e.g., square or rectangular) openings between LSR strands, with each opening measuring approximately ⅝th (five-eighths) inches by ⅝th (five-eighths) inches. The LSR grid is also laid out with a somewhat semi-circular toe-end, an opposite linear rear end for paw insertion, and parallel linear sides. The bottom portion of the boot measures approximately 5-¼ (five and one-quarter) inches in length from toe-end to rear end, and is approximately 4 (four) inches wide. A strap approximately 1 (one) inch wide and 10 (ten) inches long, is attached to the rear end of the bottom portion of the boot at a 90 (ninety) degree angle to one side of the boot.

A top portion of the boot is fused to the bottom portion of the boot at the toe-end and the sides. The top portion is not fused to the bottom portion at the rear end of the boot, leaving an opening for insertion of the animal's paw. In the preferred embodiment the top portion of the boot is approximately one inch longer at the rear end than the bottom portion. In the preferred embodiment the top portion and bottom portion and strap are all made of LSR grid similar to the LSR grid from which the bottom portion is comprised. In the preferred embodiment the top portion and bottom portion and strap are all manufactured via injection molding, thereby creating all the two portions and strap simultaneously and without seams. In the preferred embodiment the strap comprises an LSR grid that has smaller grid openings to allow for more LSR strands and less open space, thereby increasing the strength of the strap.

In the preferred embodiment the strap includes a section of hook and loop fastener along the length of the loose end of the strap. The mate sections of hook and loop fastener are attached along the length of the rear of the top portion near the edge and under the rear edge and along the length of the bottom portion of the boot. After the animal's paw is inserted into the boot the strap is looped over the top of the animal's ankle, over the rear portion of the top of the boot and attached to the top mate section of the hook and loop fastener, and under the rear of the boot, and attached to the bottom mate section of hook and loop fastener. When the boot strap is positioned to secure the boot to the animal's paw, the linear end of the top portion of the boot will be pressed below the strap to help secure the boot to the foot and to minimize forward drift of the boot while on the foot when walking.

More specifically, in the preferred embodiment the strap portion of the boot measures approximately one inch wide by approximately ten inches, and consists of three sections. The first section being approximately four inches in length and being fused with the rear end of the bottom portion of the boot. The strap consists of a solid LSR or similar thermoplastic elastomer. A hook and loop fastener measuring approximately 3-½ inches in length by approximately ½ inch wide is centered and attached to the bottom side of the strap during the injection molding process, giving an overall thickness of approximately ⅜ inch. The second section of the strap is approximately 2-½ inches long and is fused with the first section of the strap, but is not directly attached to the body of the boot. The second section of the strap consists of an LSR grid that has smaller grid openings than the body of the boot to allow for more LSR strands and less open space, thereby increasing the strength of the strap. The third section of the strap is fused with the second section of the strap at the end most distal to the first section. The third section of strap is approximately 3-½ inches in length and consists of solid LSR or similar material. The third section of strap includes a portion of hook and loop fastener measuring 3 inches by ½ inches, centered at one end of the strap and fused to the strap during the injection molding process.

An overboot is also provided for temporary protection of the animal's paw and protection of the non-slip therapeutic boot disclosed above. The overboot temporarily protects the animal's paw from hot, cold, or abrasive surfaces.

The overboot consists of a light weight or medium weight nylon upper bonded to a silicone rubber sole. The overboot is large enough to easily slip over the animal's paw as well as over the therapeutic boot disclosed above. In alternate embodiments the overboot covers several inches of the animal's leg above the ankle. The overboot provides excess material on the top portion of the overboot. The excess material folds across the top of the animal's paw, ankle, and lower leg. Folding the excess material creates an exterior shape of the overboot that conforms to the shape of the animal's paw, ankle, and lower leg. The overboot also includes two straps, one located at the rear of the overboot, and the other proximal to the animal's ankle. The straps wrap around the exterior of the overboot and are secured with hook and loop fasteners.

In one alternate embodiment elastic cords and cord locks are utilized in place of the hook and loop fasteners to secure the rear of the overboot to the animal's ankle. In another embodiment rigid cordage is utilized to secure the rear of the overboot to the animal's ankle.

In alternate embodiments the overboot may be formed using Tyvek or Gore-Tex.

In another alternate embodiment the sole of the overboot comprises rubber or silicone rubber.

It is to be understood that both the foregoing general description and the following detailed description provide embodiments of the invention and are intended to provide an overview or framework of understanding the nature and character of the invention as it is claimed.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a top view of an embodiment of the boot with the strap unfastened.

FIG. 2 is a bottom view of the embodiment disclosed in FIG. 1.

FIG. 3 is a side view of the embodiment disclosed in FIG. 1.

FIG. 4 is a toe view of the embodiment disclosed in FIG. 1.

FIG. 5 is a side view of one embodiment of the overboot.

FIG. 6 is a toe view of the embodiment of the overboot disclosed in FIG. 5.

FIG. 7 is a bottom view of the embodiment of the overboot disclosed in FIG. 5.

FIG. 8 is a top view of the embodiment of the overboot disclosed in FIG. 5.

FIG. 8A is a top view of a strap for a pet boot, according to another implementation.

FIG. 8B is a top view of a pet boot of FIG. 8A.

FIG. 9A is a bottom view of the pet boot of FIG. 8B.

FIG. 9B is a bottom view of the cuff of the pet boot of FIG. 8B showing the strap partially uncoupled.

FIG. 10A is a top view of a strap, according to another implementation.

FIG. 10B is a side view of the strap of FIG. 10A.

FIG. 11A is a top view of a strap, according to another implementation.

FIG. 11B is a side view of the strap of FIG. 11A.

FIG. 12A is a top view of a strap, according to another implementation.

FIG. 12B is a side view of the strap of FIG. 12A.

FIG. 12C is a top view of the strap of FIG. 12A with a reinforced peripheral edge.

FIG. 13A is a top view of a strap, according to another implementation.

FIG. 13B is a side view of the strap of FIG. 13A.

FIG. 13C is a top view of a strap, according to another implementation.

FIG. 13D is a side view of the strap of FIG. 13C.

FIG. 13E is a top view of a strap, according to another implementation.

FIG. 13F is a side view of the strap of FIG. 13E.

FIG. 13G is a top view of a strap, according to another implementation.

FIG. 13H is a side view of the strap of FIG. 13G.

FIG. 14A is a top view of a cuff, according to another implementation.

FIG. 14B is a top view of a cuff, according to another implementation.

FIG. 14C is a top view of a cuff, according to another implementation.

FIG. 15A is a top view of a toe guard portion, according to another implementation.

FIG. 15B is a top view of a toe guard portion, according to another implementation.

FIG. 15C is a top view of a toe guard portion, according to another implementation.

FIG. 15D is a top view of a toe guard portion, according to another implementation.

FIG. 16A is a top view of the insert of the pet boot shown in FIG. 9A.

FIG. 16B is a top view of an insert, according to another implementation.

FIG. 17A is a top view of the strands of the top portion of a body of a pet boot, according to another implementation.

FIG. 17B is a top view of the strands of the top portion of a body of a pet boot, according to another implementation.

FIG. 17C is a top view of the strands of the top portion of a body of a pet boot, according to another implementation.

FIG. 17D is a top view of the strands of the top portion of a body of a pet boot, according to another implementation.

FIG. 17E is a top view of the strands of the top portion of a body of a pet boot, according to another implementation.

FIG. 17F is a top view of the strands of the top portion of a body of a pet boot, according to another implementation.

FIG. 18A is a detail top view of the strands of the top portion of the body of the pet boot shown in FIG. 9A with the outer walls removed to show the infill.

FIG. 18B is a detail side view of the strand of FIG. 18A.

FIG. 18C is a detail top view of the strands of a top portion of a body of a pet boot, according to another implementation, with the outer walls removed to show the infill.

FIG. 18D is a detail top view of the strands of a top portion of a body of a pet boot, according to another implementation, with the outer walls removed to show the infill.

FIG. 18E is a detail top view of the strands of a top portion of a body of a pet boot, according to another implementation, with the outer walls removed to show the infill.

FIG. 18F is a detail top view of the strands of a top portion of a body of a pet boot, according to another implementation, with the outer walls removed to show the infill.

FIG. 18G is a detail top view of the strands of a top portion of a body of a pet boot, according to another implementation, with the outer walls removed to show the infill.

FIG. 19 is a top view of a double-strap boot design, according to another implementation.

### DETAILED DESCRIPTION

The devices, systems, and methods disclosed herein provides a therapeutic pet boot for therapeutically increasing traction, providing shock absorption, increasing sensitivity, increasing breathability, increasing ability to visually inspect the animal's foot while the boot is on, and improving ease of placing the boot on the animal. The devices, systems, and methods disclosed herein may be embodied in many different forms and should not be construed as limited to the specific embodiments described herein.

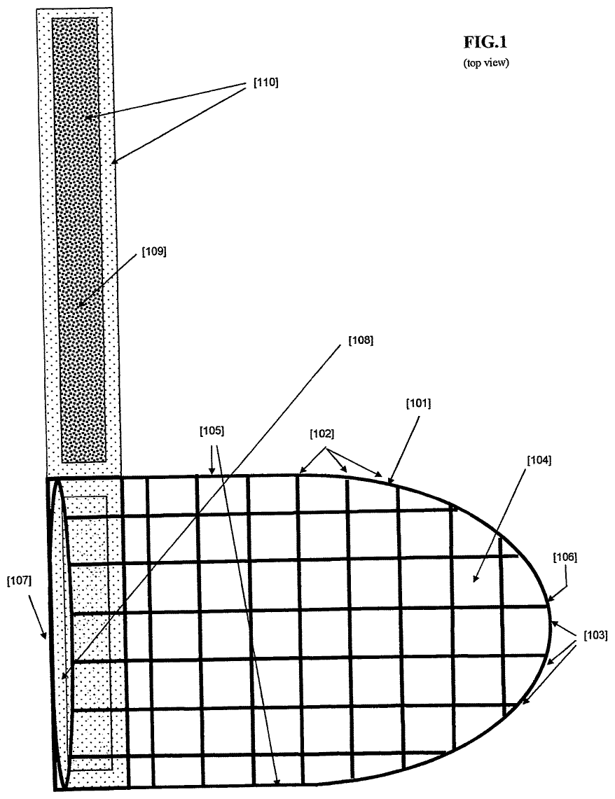

Referring to FIGS. 1, 2, 3, and 4, the preferred embodiment of the boot has a top section and a bottom section attached to each other on three sides at the edge of the top and bottom sections. Each section is made of LSR strands approximately ⅛ inch in diameter. The sections are manufactured via injection molding thereby creating all the two portions and strap simultaneously and without seams. The top and bottom sections of the boot are fused at the semi-circular end of the sections, and on the sides. The semi-circular end is the toe end of the boot. In the preferred embodiment the top section of the boot is approximately one inch longer at the rear end than the bottom section.

The top and bottom sections of the boot are not attached to each other at the rear end of the boot, thereby creating an opening for the animal's paw. The toes of the animal are slipped into this opening and the boot is slid up the animal's foot until the animal's toes reach the toe-end of the boot.

In the preferred embodiment the LSR strands are laid out in a grid, thereby creating cells between the LSR strands. Each cell is approximately ⅝ inches square for the extra large size boot. The cells are open to allow air flow through the LSR strands.

In the preferred embodiment the bottom section of the boot is approximately one inch shorter than the top section of the boot, at the rear end of the boot. A strap is attached to the bottom section of the boot extending approximately ten inches at a right angle from one side of the boot at the rear of the boot. The strap is attached along the length of the rear end of the bottom section of the boot and extends outward perpendicularly, giving an overall strap length of about ten inches. The strap includes a section of hook and loop fastener attached along the length of the loose end of the strap. Another section of hook and loop fastener is attached to the top rear of the top section of the boot. Another section of hook and loop fastener is attached to the bottom of the boot at the rear of the bottom section of the boot. After the boot has been placed on the animal's foot the strap is wrapped around the top of the animal's ankle, over the rear portion of the top of the boot, and under the rear of the boot, allowing all of the sections of hook and loop fasteners to secure the boot on the animal's foot. In alternate embodiments any known adjustable fasteners for straps are used.

Referring to FIG. 1, which is a top view of the inventive boot, the top portion of the boot 101 comprises a grid of flexible LSR strands made up of a first set of LSR strands set in parallel to each other approximately ⅝ inches apart, and a second set of LSR strands 103 also in parallel to each other but set at right angles to the first set of LSR strands. This arrangement leaves multiple square cells 104 of empty space between the LSR strands. The cells 104 allow for relatively free air flow between the animal's paw and the outside of the boot. The cells 104 also allow for visual inspection of the animal's paw without removing the boot. The cells 104 also allow foreign objects, such as dirt or small rocks, to exit the boot through normal movement of the animal, without removing the boot.

A bottom portion of the boot, made of similarly arranged LSR grid, is attached to the top portion along the edge of both the top and bottom portions of the boot at the parallel sides 105 and at the curved front of the boot 106. In the preferred embodiment the LSR making up this outer edge 105 and 106 is thicker than the LSR making up the remainder of the top and bottom portions of the boot. The top portion of the boot 101 is not attached to the bottom portion at the rear 107 of the boot, thereby leaving an opening 108 between the two portions for the animal's paw to be placed inside the boot.

At the rear of the boot 107 a strap 109 is attached along the entire length of the rear 107 of the bottom section of the boot and extends perpendicular to one side 105 of the boot at the edge of the boot. The hook portion 110 of a hook and loop fastener is attached to the strap 109 in an orientation leaving the hook portion 110 of the fastener exposed on the surface of the strap 109. After the animal's paw is inserted into the opening 108 at the rear 107 of the boot, the strap is wrapped over the rear 107 edge of the top portion of the boot 101 and attaches to the loop portion of the fastener on the top rear portion of the top of the boot and around the bottom portion of the boot to attach to the loop portion of the hook and loop fastener, which is attached to the bottom portion of the boot.

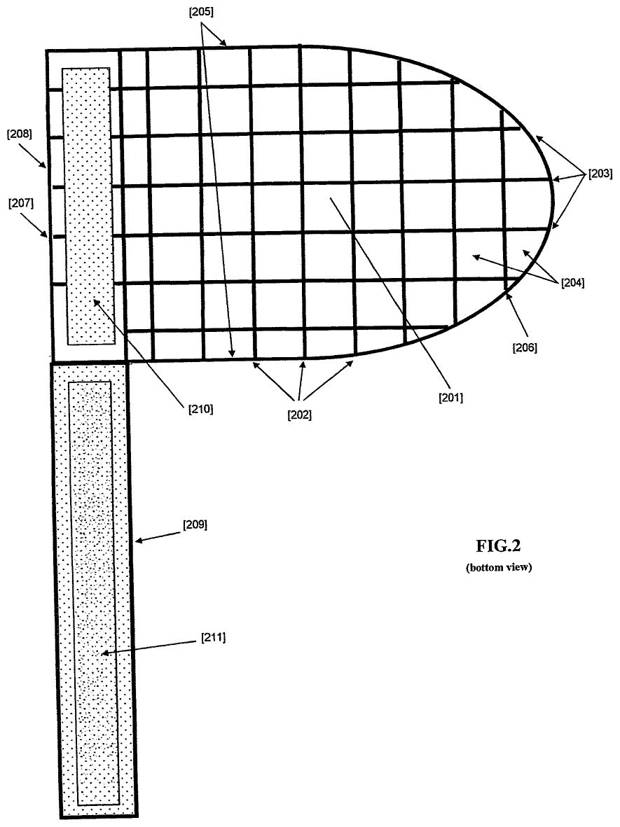

Referring to FIG. 2, which is a bottom view of the inventive boot, the bottom portion of the boot 201 comprises a grid of flexible LSR strands made up of a first set of LSR strands 202 set in parallel to each other approximately ⅝ inches apart, and a second set of LSR strands 203 also in parallel to each other but set at right angles to the first set of LSR strands.

As with the top portion of the boot 101 this arrangement leaves multiple square cells of empty space between the LSR strands 204.

A cross section of the LSR strands 202 and 203 reveals that they are approximately ⅛ inches in diameter and that the cross section is slightly oval shaped with the flatter portions of the LSR arranged to contact the animal's paw and the ground, in order to provide increased comfort under the animal's paw.

The top portion of the boot 101 is attached to the bottom portion 201 along the edge of both the top and bottom portions of the boot at the parallel sides 205 and at the curved front of the boot 206. The parallel sides 205 and curved front 206 of FIG. 2 correspond to the curved front of the boot 106 and the parallel sides 105 of FIG. 1. In the preferred embodiment the LSR making up this outer edge 205 and 206 is thicker than the LSR making up the remainder of the top and bottom portions of the boot. This outer edge 205 and 206 of FIG. 2 also corresponds to the outer edge 105 and 106 of FIG. 1. The top portion of the boot is not attached to the bottom portion 101 at the rear 207 of the boot, thereby leaving an opening 208 between the two portions for the animal's paw to be placed inside the boot. The opening 208 between the two portions of FIG. 2 corresponds to the opening 108 of FIG. 1.

At the rear of the boot 207 a strap 209 is attached along the entire length of the rear 207 of the bottom section of the boot 201 and extends perpendicular to one side 205 of the boot. The strap 209 corresponds to the strap 109 of FIG. 1. The hook portion 110 of a hook and loop fastener is attached to the strap 109/209 in an orientation leaving the hook portion 110 of the fastener exposed on the surface of the strap 109/209. The loop portions of the hook and loop fastener are attached to the top portion of the boot at the rear of the boot and are attached to the bottom portion 201 of the boot at the rear 207 of the boot in an orientation to allow it to contact the hook portion 211 of the fastener, which is attached to the strap 109/209. The hook portion of the fastener in FIG. 2 corresponds to the hook portion of the fastener 110 in FIG. 1. After the animal's paw is inserted into the opening 108/208 at the rear 107/207 of the boot, the strap is wrapped over the rear 107 edge of the top portion of the boot and around the rear 207 edge of the bottom portion 201 of the boot to attach to the hook 110/211 and loop 210 portions of the hook and loop fastener.

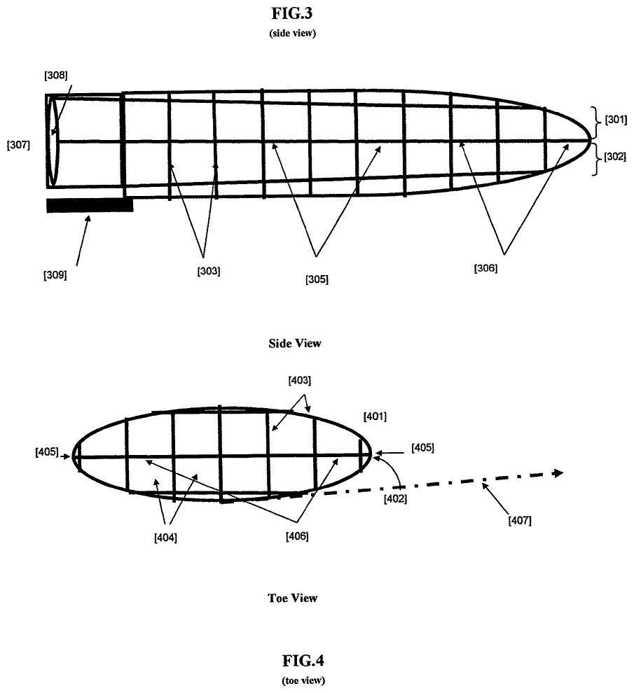

Referring to FIG. 3, which is a side view of the inventive boot, the top portion of the boot 301 and the bottom portion of the boot 302 comprise a grid of flexible LSR strands and multiple square cells 304, as previously described. The top portion 301 corresponds to the top portion 201 from FIG. 2. The bottom portion 302 corresponds to the bottom portion from FIG. 1. The top portion 301 and bottom portion 302 are attached at the edge of both the top and bottom portions of the boot at the parallel sides 305 and at the curved front of the boot 306. The parallel sides 305 and curved front 306 of FIG. 3 correspond to the curved front of the boot 106 and the parallel sides 105 of FIG. 1, and to the curved front of the boot 206 and the parallel sides 205 of FIG. 2. In the preferred embodiment the LSR making up this outer edge 305 and 306 is thicker than the LSR making up the remainder of the top and bottom portions of the boot.

The top portion of the boot 301 is not attached to the bottom portion 302 at the rear 307 of the boot, thereby leaving an opening 308 between the two portions for the animal's paw to be placed inside the boot. The opening 308 between the two portions of FIG. 3 corresponds to the opening 108 of FIG. 1 and the opening 208 of FIG. 2.

At the rear of the boot 307 a strap 309 is attached along the entire length of the rear 307 of the bottom section of the boot 302 and extends perpendicular to one side of the boot. The strap 309 corresponds to the strap 109 of FIG. 1 and to the strap 209 of FIG. 2.

Referring to FIG. 4, which is a toe view of the inventive boot, the top portion of the boot 401 and the bottom portion of the boot 402 comprise a grid of flexible LSR strands and multiple square cells 404, as previously described. The top portion 401 corresponds to the top portion 201 from FIG. 2, and to the top portion 301 from FIG. 3. The bottom portion 402 corresponds to the bottom portion 101 from FIG. 1 and to the bottom portion from FIG. 3. The top portion 401 and bottom portion 402 are attached at the edge of both the top and bottom portions of the boot at the parallel sides 405 and at the curved front of the boot 406. A strap 407 is attached is attached along the entire length of the rear of the bottom section of the boot and extends perpendicular to one side 405 of the boot. The strap corresponds to the strap 109 of FIG. 1 and to the strap 209 of FIG. 2 and to the strap of FIG. 3.

Referring next to FIGS. 5, 6, 7, and 8 the preferred embodiment of the overboot consists of a light-weight nylon upper bonded to a silicone rubber sole. The sole covers the bottom half of the overboot from the toe-end of the overboot, ending halfway between the toe end and the rear of the overboot.

The overboot is large enough to easily slip over the animal's paw as well as over the therapeutic boot disclosed above, and to cover several inches of the animal's leg above the ankle. The overboot includes excess material on the top portion of the overboot. The excess material folds across the top of the animal's paw, ankle, and lower leg. Folding the excess material creates an exterior shape of the overboot that conforms to the shape of the animal's paw, ankle, and lower leg. The overboot also includes two straps, the first strap located at the rear of the overboot and the second strap located proximal to the animal's ankle. The straps wrap around the exterior of the overboot and are secured with hook and loop fasteners.

Referring to FIG. 5, which is a side view of the inventive overboot, shown with the hook and loop fasteners 501 in the closed position (fastened) as would be found when the overboot has been placed upon the animal, the overboot includes a light-weight nylon upper bonded to a silicone rubber sole 503. The sole 503 covers the bottom half of the overboot from the toe-end 504 of the overboot, ending between the toe end 505 and the rear of the overboot.

The overboot is large enough for the rear portion 505 of the nylon upper 502 to cover several inches of the animal's leg above the ankle. The overboot includes excess material on the top portion of the overboot 506, which folds across the top of the animal's paw, ankle, and lower leg. The overboot includes an opening 507 for the animal's paw to be inserted.

The hook and loop fasteners 501 include an upper strap 508 located at the upper rear of the overboot, and a lower strap 509 located proximal to the animal's ankle. After the animal's paw is inserted into the opening 507 of the overboot, the upper strap 508 wraps around the animal's leg at the outer circumference of the opening 507. The lower strap 509 wraps around the exterior of the overboot at the animal's ankle joint. The upper strap 508 and lower strap 509 include the hook portion of hook and loop fasteners bonded to the straps. The straps wrap around the exterior of the overboot and are secured with loop fasteners which are bonded to the exterior of the overboot.

Referring to FIG. 6, which is a toe view, the inventive overboot includes a solid silicone sole 601 bonded to the lightweight nylon upper 602, and an opening 603 for insertion of the animal's paw. The sole 601, nylon upper 602, and opening 603 of FIG. 6 correspond to the sole 503, nylon upper 502, and opening 507 of FIG. 5.

The nylon upper 602 includes an upper fold 604 and a lower fold 605. The lower fold 605 allows the nylon upper 602 to be tightened around the animal's paw at the toe 606. The upper fold 604 allows the nylon upper 602 to be tightened around the animal's leg at the opening 603.

The overboot also includes an upper strap 607 and a lower strap 608. The upper strap 607 and a lower strap 608 of FIG. 6 correspond to the upper strap 508 and a lower strap 509 of FIG. 5. One end of the upper strap 607-A is attached at the front of the upper portion of the nylon upper 602 parallel to the opening 603 and the other end 607-B extends unattached away from the overboot. After the animal's paw has been inserted the unattached end of the upper strap 607-B is wrapped around the perimeter of the opening 603, enclosing the animal's paw within the nylon upper 602 and fastened to the attached end of the upper strap 607-A via hook and loop fasteners bonded to the upper strap 607.

One end of the lower strap 608-A is attached at approximately the center of the nylon upper 602 approximately where the animal's ankle joint is located, and the other end 608-B extends unattached away from the overboot. After the animal's paw has been inserted the unattached end 608-B of the lower strap 608 is wrapped around the outside of the nylon upper 602 at the animal's ankle joint and fastened to the attached end 608-A of the lower strap 608 via hook and loop fasteners bonded to the lower strap 608.

Referring to FIG. 7A, which is a bottom view, the overboot includes a silicone sole 701, a nylon upper 702, a lower strap 703, an upper strap 704, and an opening 705 for the animal's paw. The sole 701, nylon upper 702, lower strap 703, upper strap 704, and opening 705 for the animal's paw of FIG. 7A correspond to the sole 601, nylon upper 602, lower strap 608, upper strap 607, and opening 603 for the animal's paw of FIG. 6, and the sole 503, nylon upper 502, lower strap 509, upper strap 508, and opening 507 for the animal's paw of FIG. 5.

The silicone sole 701 is bonded to the bottom portion of the nylon upper 702 from the toe 706 to the lower strap 703, located at approximately the location of the animal's ankle.

Referring to FIG. 7B, which is a top view, the overboot includes a nylon upper 801, a lower strap 802, an upper strap 803, an opening 804 for the animal's paw, and a toe 805. The nylon upper 801, lower strap 802, upper strap 803, opening 804, and toe 805 of FIG. 7B correspond to the nylon upper 702, lower strap 703, upper strap 704, opening 705, and toe 706 of FIG. 7; to the nylon upper 602, lower strap 608, upper strap 607, opening 603, and toe 606 of FIG. 6; and the nylon upper 502, lower strap 509, upper strap 508, opening 507, and toe 504 of FIG. 5.

The overboot also includes excess material 806 in the nylon upper 801 to allow for folding the nylon upper 801 to tighten the overboot around the animal's leg. The excess material 806 of FIG. 7B corresponds to the excess material 506 of FIG. 5. The excess material 806 is divided into an interior section 806-A and an exterior section 806-B. The interior section 806-A is triangular with one side beginning from the toe 805 to one side 806-C of the opening 804, a second side extending from the side 806-C to a point 806-D located approximately halfway between the side 806-C and a second side 806-E of the opening 804, and a third side extending from the point 806-D to the toe 805. The exterior section 806-B is also triangular with one side beginning from the toe 805 to the second side 806-E of the opening 804, a second side extending from the side 806-E to the point 806-D, and a third side extending from the point 806-D to the toe 805.

After the animal's leg is inserted into the overboot the exterior section 805B of the excess material 805 is folded over the interior section 805-A of the excess material. The upper strap 803 and lower strap 802 are then wrapped around the exterior of the nylon upper and fastened via hook and loop fasteners that are bonded to the upper strap 803 and lower strap 802, thereby securing the animal's paw within the overboot.

Various other implementations include a pet boot. The boot includes a body and a cuff. The body has a top portion and a bottom portion coupled to the top portion. The top portion and the bottom portion define an inner cavity and an ankle opening defined by an outer surface of the body and extending to the inner cavity. The cuff includes a plurality of strands and a band. The plurality of strands each have a first end and a second end spaced apart and opposite the first end. The second end of each strand is coupled to the body adjacent the ankle opening. The band forms a loop. The first end of each of the strands is coupled to the band. Each of the stands are spaced apart from each other around the ankle opening such that a plurality of cuff openings are defined by the plurality of strands, the band, and the body.

Various other implementations include a pet boot. The boot includes a body, a cuff, a strap, and an insert. The body has a top portion and a bottom portion coupled to the top portion. The top portion and the bottom portion define an inner cavity and an ankle opening defined by an outer surface of the body and extending to the inner cavity. The cuff forms a loop. The cuff is coupled to the body around the ankle opening. The cuff defines a plurality of cuff openings circumferentially spaced around the loop. The strap is separately formed from the body and cuff. The strap is threaded through the plurality of cuff openings. The insert defines two or more insert openings. The strap is threaded through the two or more insert openings.

Various other implementations include a pet boot. The boot includes a body and a cuff. The body has a top portion and a bottom portion coupled to the top portion. The top portion and the bottom portion define an inner cavity and an ankle opening defined by an outer surface of the body and extending to the inner cavity. The cuff forms a loop. The cuff is coupled to the body around the ankle opening. The cuff defines a plurality of cuff openings circumferentially spaced around the loop. The top portion and the bottom portion of the body each define a plurality of body openings. The body openings extend from the outer surface of the body to the inner cavity. A portion of the body opposite the ankle opening comprises a toe guard portion. The toe guard portion of the top portion and the bottom portion of the body do not define body openings.

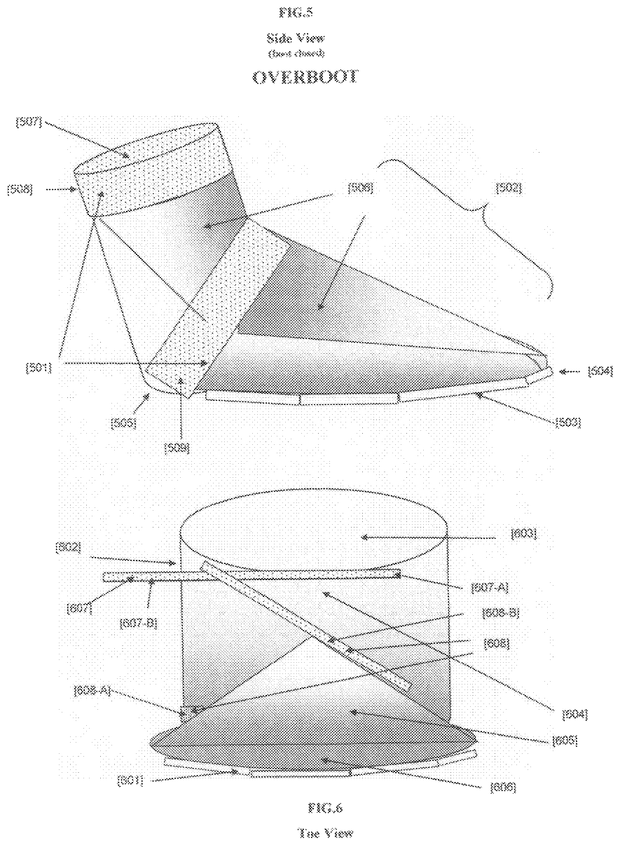

FIGS. 8A-9B show a pet boot 800 having various aspects according to some implementations. The boot 800 includes a body 802, a cuff 830, a strap 850, an insert 880, and a toe guard 808.

The body 802 has a top portion 804 and a bottom portion 806 coupled to the top portion 804. The top portion 804 and the bottom portion 806 are coupled to each other along a portion of their respective perimetrical edges to define an inner cavity 810 of the body 802.

Each of the top portion 804 and the bottom portion 806 of the body 802 include an elastomer. However, in some implementations, the top portion and the bottom portion of the body can include any polymer or other flexible material capable of providing a cushioned layer for the pet's foot. In some implementations, the top portion and/or the bottom portion of the body can include a biopolymer.

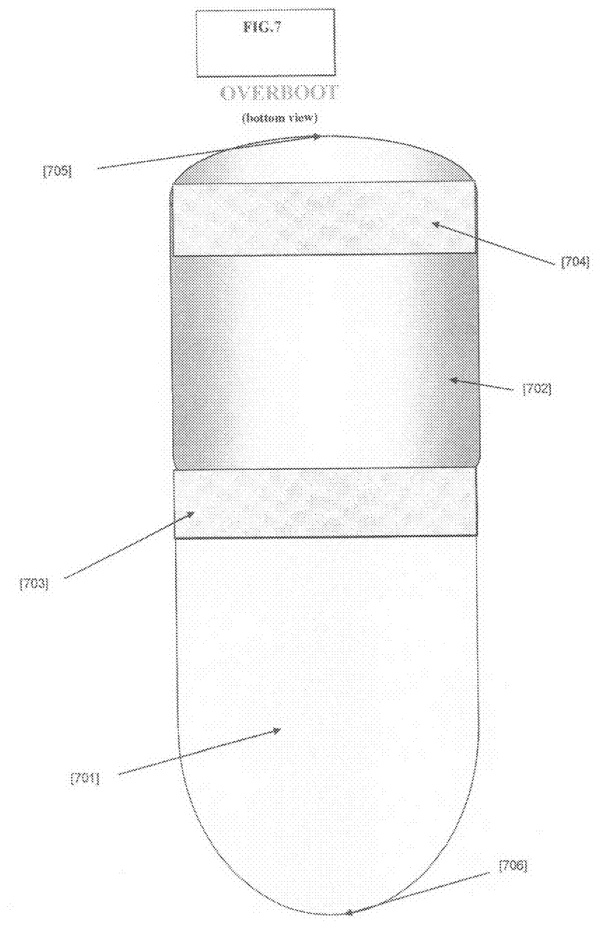

A portion of the perimetrical edges of the top portion 804 and bottom portion 806 are not coupled to each other to define a leg opening 812. The leg opening 812 shown in FIGS. 8A-9B is an ankle opening, but in some implementations, the leg opening may be configured to be positioned at the ankle of a pet when in use, such as in the implementations shown in FIGS. 1-18B. In some implementations, the leg opening may be configured to be positioned at or above the carpus (wrist) or at or above the hock (ankle) of the pet when in use, as shown in FIG. 19. The ankle opening 812 shown in FIGS. 8A-9B is defined by an outer surface of the body 802 and extends to the inner cavity 810.

The body 802 of the boot 800 can be made in any size to fit a pet's foot. The boot 800 shown in FIGS. 8A-9B is 4.0 inches in width, but in some implementations, the width of the body of the boot can be 1.0 inch, 1.5 inches, 2.0 inches, 2.5 inches, 3.0 inches, 3.5 inches, 4.5 inches, 5.0 inches, 5.5 inches, 6.0 inches, or any other width.

The top portion 804 and the bottom portion 806 of the body 802 are each formed of flexible strands 820 arranged in a grid pattern. The strands 820 are integrally coupled to each other and define a plurality of body openings 822 between the grid of stands 820. The body openings 822 extend from the outer surface of the body 802 to the inner cavity 810. However, in some implementations, the top portion and/or the bottom portion of the body of the boot do not include strands. In some implementations, the top portion and/or the bottom portion of the body include one or more portions that define the body openings extending from the outer surface of the body to the inner cavity. The body openings 822 shown in the figures are quadrilateral-shaped (e.g., rectangular, square, kite-shaped), but in some implementations, the body openings can be any closed shape.

The strands 820 of the body 802 shown in FIG. 8A-9B have an oval cross-section and are 0.35 inches wide and 0.125 inches thick. However, in some implementations, the strands of the body can have any cross-sectional shape, such as circular, elliptical, semi-circular with a flat surface away from the inner cavity, semi-circular with a flat surface towards the inner cavity, square, rectangular, a multi-sided polyhedron (such as a hexagon, a quadrilateral polyhedron, a triangle with its point away from inner cavity, or a triangle with its point towards from inner cavity) or any closed shape. In some implementations, the strands of the body can have any width and any thickness based on a desired support of the pet's foot.

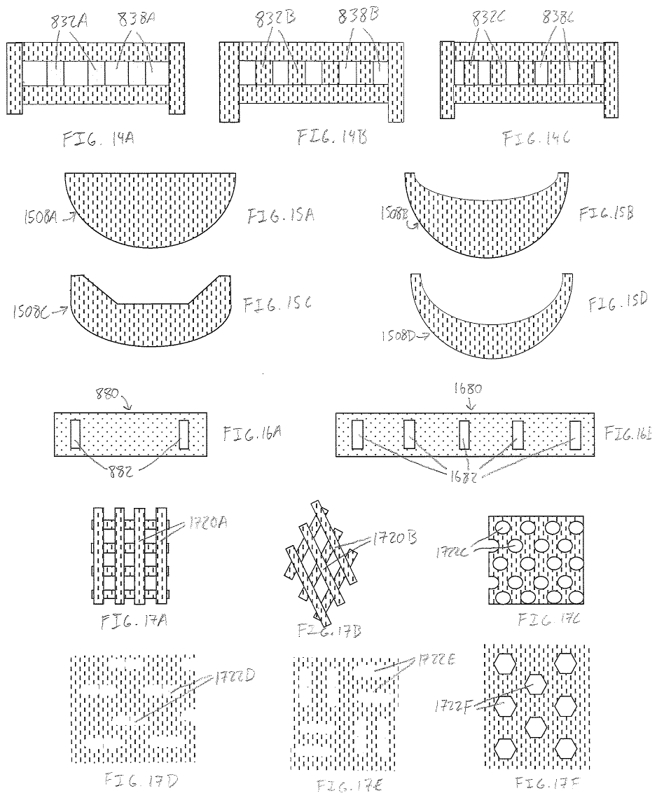

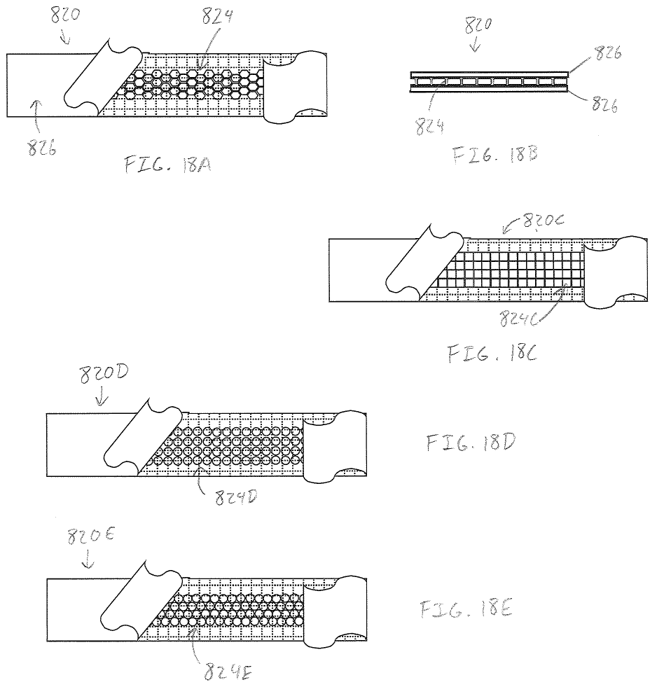

The body openings 822 shown in FIG. 8A-9B are formed by a grid and have a square or diamond shape as viewed externally from the top portion 804 or the bottom portion 806 of the body 802 of the boot 800. However, in some implementations, the body openings have a quadrilateral (e.g., rectangular or square) shape as viewed externally from the top portion or the bottom portion of the body of the boot. In some implementations, the body openings 1722C, 1722D, 1722E have a circular shape (see FIG. 17C) or ovate shape (see FIGS. 17D and 17E) as viewed externally from the top portion or the bottom portion of the body of the boot. In some implementations, the body openings 1722F have a hexagonal shape (see FIG. 17F) or any other closed shape as viewed externally from the top portion or the bottom portion of the body of the boot. In some implementations, the strands 1720A can extend parallel and perpendicular to a length of the boot, as shown in FIG. 17A. In some implementations, the strands 820 can extend at a 45-degree angle to parallel and perpendicular to a length of the boot, as shown in FIGS. 8A-9B. In some implementations, the strands can intersect at a 90-degree angle. In some implementations, the strands 1720B can intersect at an obtuse and an acute angle, as shown in FIG. 17B. In some implementations, the corners of the body openings can be webbed such that the strand material rounds the corners of the body openings.

Although the body openings 822 of the top portion 804 and the bottom portion 806 of the body 802 of the boot 800 shown in FIGS. 8A-9B are the same shape, in some implementations, the plurality of body openings of the top portion are a different shape than the shape of the plurality of body openings of the bottom portion as viewed externally from the top portion or the bottom portion, respectively, of the body of the boot.

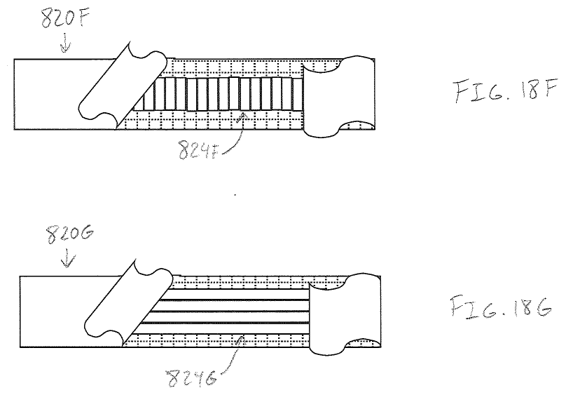

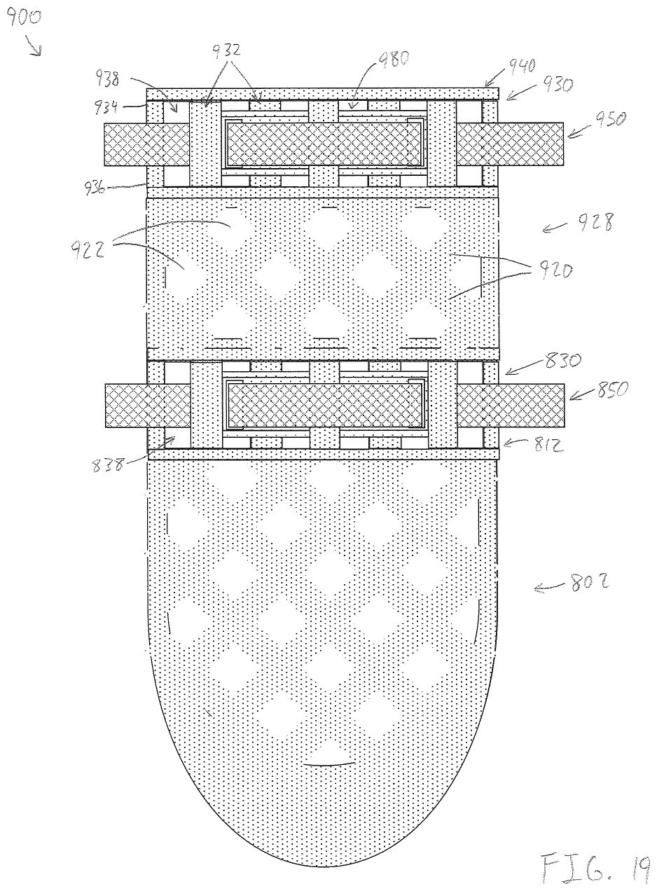

The strands 820 of the body 802 of the boot 800 shown in FIGS. 8A-9B include a hexagonal “infill” 824 surrounded by an outer wall 826, as shown in FIGS. 18A-18B. The infill 824 is a repeating pattern of material formed within the outer wall 826 to reduce material usage, cost, and weight. The use of infill 824 also creates air pockets within the strands 820 of the body 802 to provide extra cushion to the foot of the pet. The hexagonal shape of the infill 824 of the strands 820 of the body 802 shown in FIGS. 18A-18B are oriented such that the openings of the hexagons extend across the thickness of the strand 820. However, in some implementations, the openings of the infill 824F, 824G shape of the strand 820F, 820G can be oriented to extend across the width of the strand 820F (see FIG. 18F) or along the length of the strand 820G (see FIG. 18G). In some implementations, the infill 824D, 824C, 824E of the strand 820D, 820C, 820E has a different shape, such as circular (see FIG. 18D), square (see FIG. 18C), oblique (see FIG. 18E), rectangular, triangular, or any other closed shape. In some implementations, the infill can include any other pattern, such as concentric shapes, a grid, random lines, tri-hexagon, gyroid, adaptive cubic, Hilbert curve, Archimedean curve, spiral, or any other known infill pattern. In some implementations, the strands of the top portion of the body and the strands of the bottom portion of the body have the same infill as each other or different infill from each other. In some implementations, the strands of one or both of the top portion or the bottom portion of the body does not include infill.

A portion of the body 802 opposite the ankle opening 812 in FIGS. 8A-9B includes a toe guard portion 808. The toe guard portion 808 of the top portion 804 and the bottom portion 806 of the body 802 do not define body openings 822. Thus, the toe guard portion 808 includes solid material to protect the toes of the pet from harm from external objects.

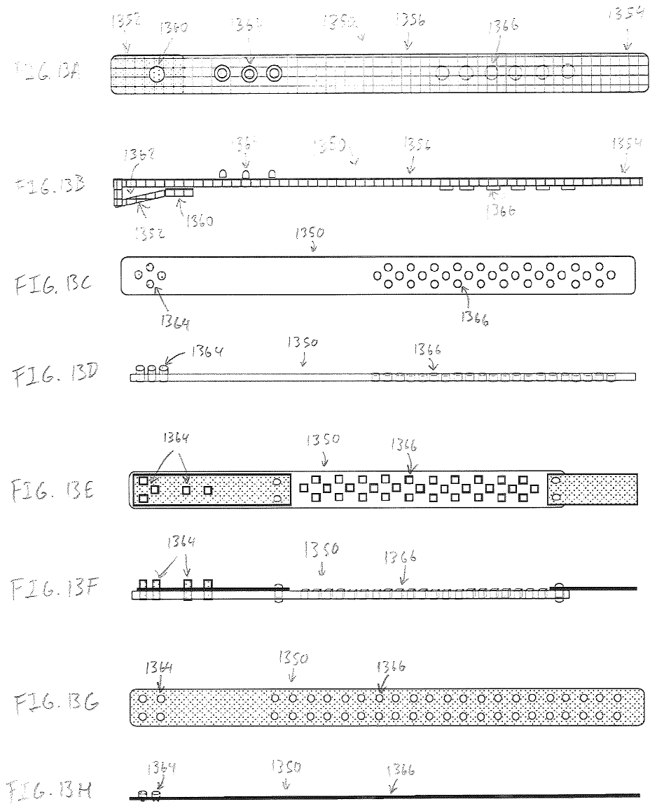

The toe guard portion 808 of the top portion 804 and the bottom portion 806 shown in FIGS. 8A-9B are each C-shaped portions of the top portion 804 and the bottom portion 806 of the body 802 of the boot 800. This shape provides full coverage of the toes of the pet. In some implementations, the toe guard portion 1508A of the top portion and the bottom portion of the body are each semi-circular shaped, as shown in FIG. 15A. In some implementations, the toe guard portion 1508B, 1508D of the top portion and the bottom portion of the body are each crescent shaped, as shown in FIGS. 15B and 15D. In some implementations, the toe guard portion 1508C of the top portion and the bottom portion of the body are each a polygonal C-shape, as shown in FIG. 15C. These shapes also provide full coverage of the toes of the pet but allow for a maximum number of body openings in the top portion and the bottom portion of the body. In some implementations, the toe guard portion of the top portion and the bottom portion of the body can be any shape that provides full or partial coverage of any number of toes of the pet. Additionally, in some implementations, the toe guard portion of the top portion can have a shape that is different from the shape of the toe guard portion of the bottom portion. In some implementations, the top portion includes a toe guard, but the bottom portion does not include a toe guard portion. In some implementations, the bottom portion includes a toe guard, but the top portion does not include a toe guard portion. In some implementations, the top portion and the bottom portion do not include a toe guard portion.

In some implementations, the toe guard portions of the top portion and/or the bottom portion can be made of the same material as the rest of the top portion and/or bottom portion, respectively. In some implementations, the toe guard portions of the top portion and/or the bottom portion can be made of a different material than the rest of the top portion and/or bottom portion, respectively. The toe guard portions can be made of a more durable, more rigid, or more flexible material as desired.

The cuff shown in FIGS. 8A-9B includes a plurality of strands 832 and a band 840. The plurality of strands 832 each have a first end 834 and a second end 836 spaced apart and opposite the first end 834. The second end 836 of each strand 832 is coupled to the body 802 adjacent the ankle opening 812.

The first ends 834 of each of the strands 832 is coupled to the band 840. The band 840 is a loop having a similar length to the length of the perimetrical edge of the ankle opening 812. The strands 832 and the band 840 can be made of the same material as the top portion 804 and/or bottom portion 806 of the body 802. However, in some implementations, the strands and/or band can be made of a different material than the top portion and/or bottom portion of the body.

Each of the stands 832 of the cuff 830 are spaced apart from each other around the perimetrical edge of the ankle opening 812 such that a plurality of cuff openings 838 are defined by the plurality of strands 832, the band 840, and the body 802.

Each of the strands 832 and the band 840 of the cuff 830 can be made of an elastomer. However, in some implementations, the strands and the band of the cuff can include any polymer or other flexible material capable of providing a cushioned layer for the pet. In some implementations, the strands and the band of the cuff can include a biopolymer.

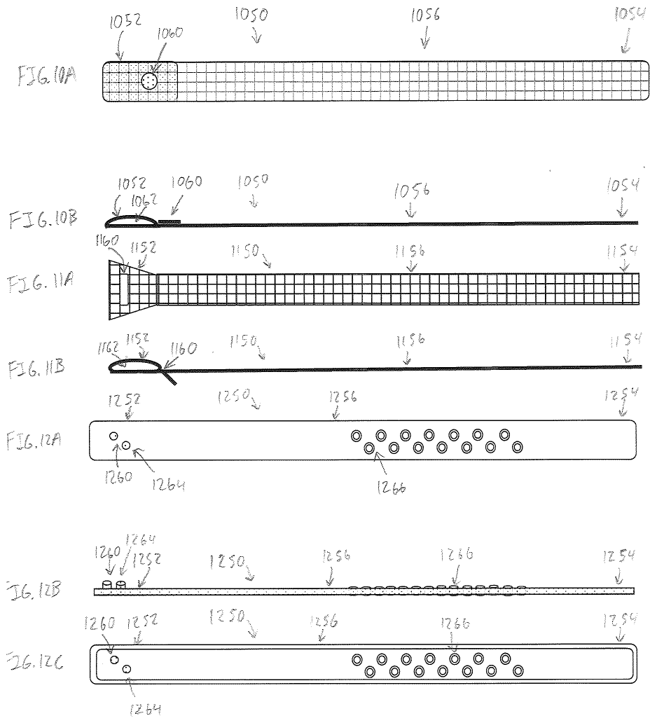

The strands 832 of the cuff 830 shown in FIGS. 8A-9B are 1 inch long as measured from the first end 834 of the strand 832 to the second end 836 of the strand 832. Thus, the cuff openings 838 shown in FIGS. 8A-9B have a height of 1 inch. The cuff openings 838 also have a width of 0.33 inches. However, as shown in FIGS. 14A-C, the number and sizes of the strands 832A, 832B, 832C can be selected to provide the desired number of cuff openings 838A, 838B, 838C and sizes of cuff openings 838A, 838B, 838C.

The strap 850 shown in FIGS. 8A-9B is separately formed from the body 802 and cuff 830 of the boot 800. The strap 850 is an elongated member made of a flexible and resilient material. The strap 850 is threaded or woven through the plurality of cuff openings 838 by being alternately extended through adjacent cuff openings 838 in inward and outward directions.

The strap 850 has a first end portion 852, a second end portion 854 opposite and spaced apart from the first end portion 852, and a middle portion 856 disposed between the first end portion 852 and the second end portion 854. The first end portion 852 of the strap 850 shown in FIGS. 8A-9B is couplable to the cuff 830. As shown in FIGS. 10A-13B, the first end portion 1052, 1152, 1252, 1352 of the strap 1050, 1150, 1250, 1350 can include a fastener 1060, 1160, 1260, 1360 such as a rivet, snap, opening, or other fastener half, and the middle portion 1056, 1156, 1256, 1356 of the strap 1050, 1150, 1250, 1350 can include a corresponding fastener half. The first end portion 1052, 1152, 1252, 1352 can be doubled back on the middle portion 1056, 1156, 1256, 1356 of the strap 1050, 1150, 1250, 1350 to fasten the first end portion 1052, 1152, 1252, 1352 to the middle portion 1056, 1156, 1256, 1356, creating a strap loop 1062, 1162, 1362 in the strap 1050, 1150, 1250, 1350. This allows the first end portion 852 of the strap 850 to be coupled to a strand 832 of the cuff 830 by disposing the strand 832 within the strap loop 862. The strap 850 can then be temporarily coupled to the cuff 830 and body 802 of the boot 800 such that the strap 850 cannot rotate relative to the cuff 830 and body 802 when the second end portion 1054, 1154, 1254, 1354 is threaded through the cuff openings 838. However, if the strap 850 becomes damaged or needs to be cleaned, the strap 850 can be removed from the cuff 830 and body 802 and can be replaced or cleaned. A new or cleaned strap 850 can then be reattached to the cuff 830 and body 802 of the boot 800.

The insert 880 can be coupled along a portion of the strap 850 to prevent the cuff 830 and body 802 of the boot 800 from rotating relative to the pet's foot. The insert 880 defines two or more insert openings 882. For the insert 880 shown in FIGS. 8A-9B and 16A, the insert 880 defines two insert openings 882, with one insert opening 882 on either end of the insert 880. However, in some implementations, the insert can include any number of two or more insert openings, such as the insert 1680 shown in FIG. 16B that defines five insert openings 1682. The strap 850 can be threaded through the two or more insert openings 882 to couple the insert 880 to the strap 850. As shown in FIGS. 8A-9B, the strap 850 can be threaded through the two or more insert openings 882 such that at least one strand 832 of the cuff 830 is disposed between the strap 850 and the insert 880. This couples the insert 880 to the cuff 830 to prevent the insert 880 from sliding along the length of the strap 850 and rotating around the cuff 830 and pet's foot.

In some implementations, the insert is made of or includes a material that has a higher durability than the strap. In some implementations, the insert has physical features such as a thickness, ribs, or other features that make the insert have a higher durability than the strap. The relatively higher durability of the insert can help the insert stay in position on the ankle of the pet and prevent it from deforming. The insert 880 shown in FIGS. 8A-9B is 0.125 inches in thickness with a raised 0.1875 inch perimeter 884, which provides a higher durability and rigidity than the strap 850. The raised perimeter 884 extends from the first side 890 of the insert 880 to prevent the raised portion 884 from rubbing against the pet's ankle. The insert 880 shown in FIGS. 8A-9B is 1.5 inches long, but in some implementations, the insert can have any length. The insert 880 shown in FIGS. 8A-9B is 0.75 inches wide, but in some implementations, the insert can have any width.

The insert 880 has a first side 890 and a second side 892 opposite the first side 890 of the insert 880. The second side 892 of the insert 880 includes a relatively smooth surface that is intended to face inwardly toward the ankle of the pet. This helps prevent the insert 880 from rubbing against and damaging the ankle of the pet.

As shown in FIGS. 8A-9B, 12A-12C, and 13A-13B, the first side 890 of the insert 880 includes one or more nubs 894 extending away from the insert 880. The strap 850 has a first side 870 and a second side 872 opposite the first side 870 of the strap 850. The strap 850 includes one or more strap openings 874 that each extends from the first side 870 of the strap 850 to the second side 872 of the strap 850. The strap openings 874 are located in locations that correspond to the locations of the nubs 894 of the insert 880. When the strap 850 is threaded through the insert openings 882, the nubs 894 of the insert 880 are insertable through the strap openings 874 such that the insert 880 is prevented from sliding relative to the strap 850.

Although the insert 880 includes nubs 894 and the strap 850 includes strap openings 874 in FIGS. 8A-9B, in some implementations, the insert includes openings and the strap includes corresponding nubs. In some implementations, the insert and/or the strap include any couplers such as snaps, hook and loop, grooves, or any other corresponding couplers to couple the insert to the strap to prevent the insert from sliding relative to the strap. In some implementations, the strap and insert do not include any couplers for coupling the insert to the strap.

The first side 870 of the strap 850 shown in FIGS. 8A-11B includes hooks of a hook-and-loop coupler 876, and the second side 872 includes loops of the hook-and-loop coupler 876. When the strap 850 is threaded through the consecutive cuff openings 838 such that the strap 850 extends fully around the cuff 830, the hooks of the hook-and-loop coupler 876 on the first side 870 of the strap 850 can be removably coupled to the loops of the hook-and-loop coupler 876 on the second side 872 of the strap 850. This allows the strap 850 to be tightened to a desired tightness around the ankle of the pet and then temporarily fastened to itself to maintain the tightness. When removing the boot 800 from the pet, the hook-and-loop coupler 876 can be uncoupled to release the tightness of the strap 850 such that the boot 800 can be removed.

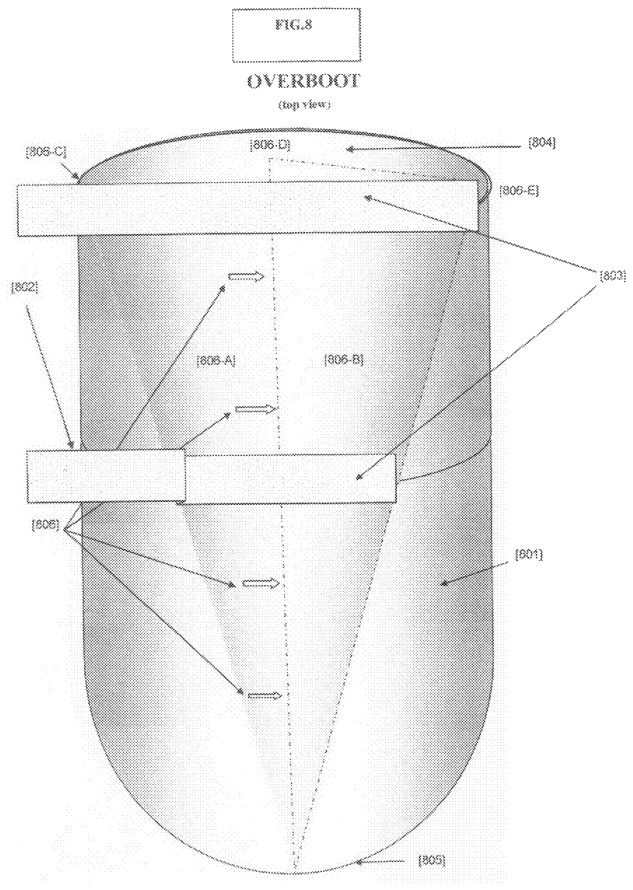

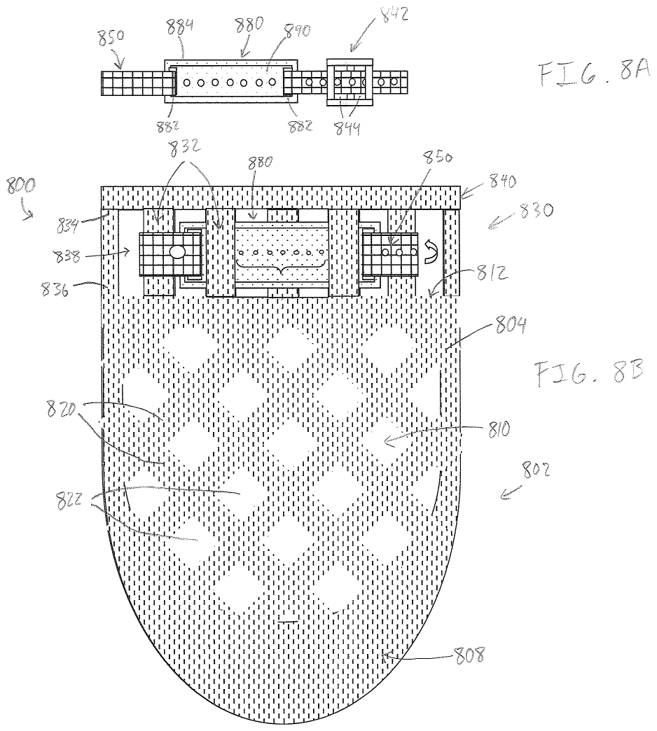

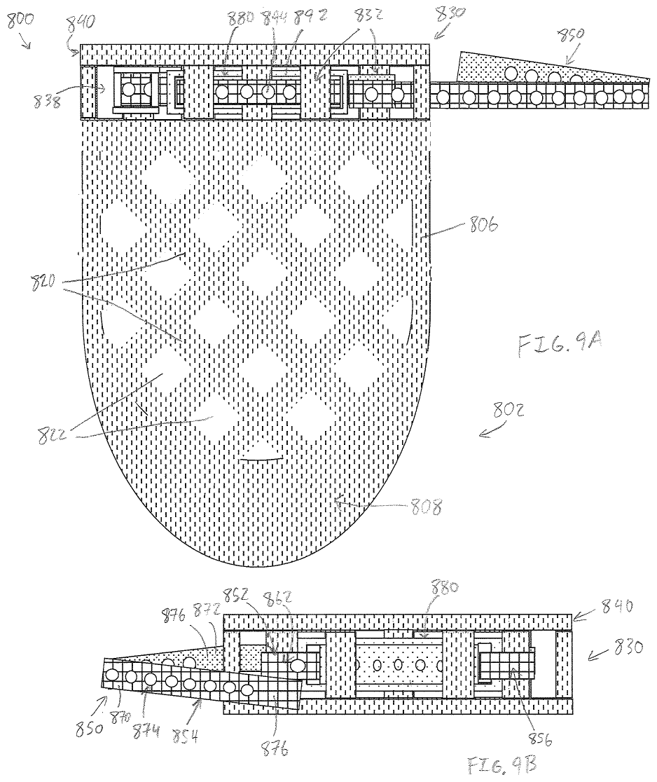

In some implementations, such as the straps 1250, 1350 shown in FIGS. 12A-13H the strap 1250, 1350 includes a first portion including one or more nubs 1264, 1364 extending away from the first side and a second portion defining one or more nub openings 1266, 1366 extending from the first side of the strap 1250, 1350 to the second side of the strap 1250, 1350. The nubs 1264, 1364 and openings 1266, 1366 are arranged such that, when the strap 1250, 1350 extends around the cuff, the one or more nubs 1264, 1364 of the first portion of the strap 1250, 1350 are disposable within the one or more nub openings 1266, 1366 of the second portion of the strap 1250, 1350.

The strap 850 and insert 880 shown in FIGS. 8A-9B are made of an elastomer. However, in some implementations, the strap and insert can include any polymer or other flexible material capable of providing a cushioned layer for the pet. In some implementations, the strap can be made of or include a thermo-elastomer, leather, shock cord, or any other material. In some implementations, the strap and insert can include a biopolymer.

The strap 850 shown in FIGS. 8A-9B is 0.5 inches wide, but in some implementations, the strap can be any width.

Although the boot 800 shown in FIGS. 8A-9B includes only one insert 880, in some implementations, the boot can include any number of two or more inserts each threaded onto a portion of the strap such that the inserts are located at desired locations around the cuff. The additional inserts can help prevent rotation of the cuff and body of the boot relative to the foot of the pet.

The boot 800 can also include a buckle 842, such as the one shown in FIGS. 8A-9B. The buckle 842 includes two or more buckle openings 844. The strap 850 can be threaded through the two or more buckle openings 844 of the buckle 842. When the strap 850 extends around the cuff 830 and back on top of itself, the second end 854 of the strap 850 can be threaded back through the two or more buckle openings 844 of the buckle 842 such that the buckle 842 retains the second end 854 of the strap 850.

FIG. 19 shows another implementation of a boot 900 similar to the boot 800 shown in FIGS. 18A-19B, but the boot 900 shown in FIG. 19 further includes an extension portion 928 coupled to the body 802 and extending proximally from the leg opening 812.

Similar reference numbers to those used for the features of boot 800 shown in FIGS. 8A-9B are used for similar features of the boot 900 shown in FIG. 19. The extension portion 928 may be configured to extend to or above a carpus or hock of the pet, providing additional coverage and support for pets with mobility challenges. The extension portion 928 may be particularly beneficial for pets suffering from conditions such as Wobblers Syndrome, arthritis, or hip dysplasia, as it can provide enhanced stability and support during movement transitions such as rising from or lying down to a prone position.

The extension portion 928 may define a plurality of extension openings 922 extending through the extension portion 928 to provide airflow around the pet's limb. In some implementations, the extension portion 928 comprises flexible strands 920 arranged in a grid pattern, wherein the flexible strands 920 define extension openings 922 between the strands 920. The strands 920 and extension openings 922 of the extension portion 928 may have the same dimensions and spacing as the main boot body 802, or may differ in size and spacing depending on the specific therapeutic needs of the pet. For example, the extension portion 928 may include strands 920 that are thicker or thinner than those in the main boot body 802, and the extension openings 922 may be larger or smaller to optimize airflow, flexibility, or support characteristics.

In some implementations, the strands 920 of the extension portion 928 may be formed of the same elastomeric material as the main boot body 802, or may incorporate different materials to achieve desired flexibility, durability, or comfort characteristics. The extension portion 928 may maintain the same breathable, open-grid construction as the main boot 900 to ensure adequate ventilation and prevent moisture buildup around the pet's limb.

In some implementations, the cuff 830 is a first cuff, and the extension portion 928 includes a second cuff 930 spaced apart from the first cuff 830. The second cuff 930 may be positioned at or near the upper end of the extension portion 928 and may define a plurality of second cuff openings 938 circumferentially spaced around the extension portion 928. The second cuff 930 may include a plurality of strands 932 and a band 940 similar to the first cuff 830, with each strand 932 having a first end 934 coupled to the band 940 and a second end 936 coupled to the extension portion 928. The second cuff openings 938 may be sized and spaced to accommodate a second strap 950 for securing the upper portion of the boot 900 to the pet's limb.

In some implementations, the boot 900 further includes a second strap 950, similar to the first strap 850, separately formed from the body 802, first cuff 830, second cuff 930, and extension portion 928. The second strap 950 may be threaded through the plurality of second cuff openings 938 in a manner similar to how the first strap 850 is threaded through the first cuff openings 838. The second strap 950 may include similar features to the first strap 850, such as hook-and-loop fasteners, nubs and openings for coupling, or other fastening mechanisms, or any other features disclosed herein for the first strap 850. The second strap 950 may also include one or more inserts 980, similar to the inserts 880 disclosed herein, to prevent rotation and provide additional stability at the upper portion of the extension portion 928.

The extension portion 928 may be manufactured as an integral part of the boot body 802 using injection molding or other suitable manufacturing processes, or may be separately formed and subsequently attached to the main boot body 802. In some implementations, the extension portion 928 may be removably coupled to the main boot body 802, allowing for customization based on the specific needs of the pet or the severity of their condition.

The interaction of these elements provides enhanced therapeutic benefits for pets with mobility challenges. The extension portion 928 works in conjunction with the main boot body 802 to provide comprehensive support from the pet's toes to above the ankle joint. The dual-strap configuration allows for independent adjustment of tightness at two different points along the pet's limb, ensuring optimal fit and comfort while preventing the boot 900 from sliding or rotating during use. The breathable construction of both the main body 802 and extension portion 928 maintains airflow around the entire covered area of the pet's limb, preventing moisture buildup and allowing for extended wear periods. The grid pattern of openings throughout both the main body 802 and extension portion 928 enables visual inspection of the pet's limb condition without requiring boot 900 removal, while also allowing debris to naturally dislodge during normal movement. This comprehensive design approach addresses the specific needs of pets with chronic walking disabilities by providing increased traction, shock absorption, tactile sensitivity, breathability, and ease of inspection while maintaining secure attachment and improved mobility assistance.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise.

The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A pet boot, the boot comprising:
a body having a top portion and a bottom portion coupled to the top portion, wherein the top portion and the bottom portion define an inner cavity and a leg opening defined by an outer surface of the body and extending to the inner cavity; and
a cuff comprising:
a plurality of strands each having a first end and a second end spaced apart and opposite the first end, wherein the second end of each strand is coupled to the body adjacent the leg opening, and
a band forming a loop, wherein the first end of each of the strands is coupled to the band,
wherein each of the stands are spaced apart from each other around the leg opening such that a plurality of cuff openings are defined by the plurality of strands, the band, and the body.

2. The boot of claim 1, further comprising a strap separately formed from the body and cuff, wherein the strap is threaded through the plurality of cuff openings.

3. The boot of claim 2, wherein the strap has a first end portion and a second end portion opposite and spaced apart from the first end portion, wherein the first end portion is couplable to the cuff.

4. The boot of claim 3, wherein the strap further has a middle portion disposed between the first end portion and the second end portion, wherein the first end portion of the strap is couplable to the middle portion to form a strap loop, wherein a strand of the cuff is disposable within the strap loop to couple the first end portion of the strap to the cuff.

5. The boot of claim 2, further comprising an insert defining two or more insert openings, wherein the strap is threaded through the two or more insert openings.

6. The boot of claim 5, wherein the strap is threaded through the two or more insert openings such that at least one strand of the cuff is disposed between the strap and the insert.

7. The boot of claim 5, wherein the strap has a first side and a second side opposite the first side, wherein the insert includes one or more nubs extending away from the insert, wherein the second side of the strap defines one or more nub openings extending to the first side of the strap, wherein the one or more nubs are disposable within the one or more nub openings.

8. The boot of claim 5, wherein the insert has a higher durability than the strap.

9. The boot of claim 2, wherein the strap has a first side and a second side opposite the first side, wherein the first side includes hooks of a hook-and-loop coupler, wherein the second side includes loops of the hook-and-loop coupler.

10. The boot of claim 2, wherein the strap has a first side and a second side opposite the first side, wherein the first side includes one or more nubs extending away from the first side, wherein the second side defines one or more nub openings extending to the first side, wherein the one or more nubs are disposable within the one or more nub openings.

11. The boot of claim 2, wherein the strap comprises an elastomer.

12. The boot of claim 1, wherein the top portion and the bottom portion of the body each define a plurality of body openings, wherein the body openings extend from the outer surface of the body to the inner cavity, wherein the body openings are quadrilateral.

13.-16. (canceled)

17. The boot of claim 12, wherein a portion of the body opposite the leg opening comprises a toe guard portion, wherein the toe guard portion of the top portion and the bottom portion of the body do not define body openings.

18. The boot of claim 17, wherein the toe guard portion of the top portion and the bottom portion are each semi-circular shaped or crescent shaped.

19. (canceled)

20. The boot of claim 1, wherein the body and cuff each comprise an elastomer.

21. The boot of claim 1, wherein the leg opening is configured to be positioned at the ankle of a pet in use.

22. The boot of claim 1, further comprising an extension portion coupled to the body and extending proximally from the leg opening, wherein the extension portion is configured to extend to or above a carpus or hock of the pet.

23. The boot of claim 22, wherein the cuff is a first cuff, wherein the extension portion includes a second cuff spaced apart from the first cuff, wherein the second cuff defines a plurality of second cuff openings circumferentially spaced around the extension portion.

24. The boot of claim 23, further comprising a second strap separately formed from the body, first cuff, second cuff, and extension portion, wherein the second strap is threaded through the plurality of second cuff openings.

25. The boot of claim 24, further comprising a second insert defining two or more second strap insert openings, wherein the second strap is threaded through the two or more second strap insert openings.

26.-73. (canceled)
